(19) United States
(12) Patent Application Publication
(10) Pub. No.: US 2023/0316425 A1
(43) Pub. Date: Oct. 5, 2023

(54) COMPUTER IMPLIMENTED SYSTEM AND METHOD TO CREATE WISDOM NETWORK

(71) Applicant: SOHAIL MAHAMMAD, Bhadradri Kothagudem (IN)

(72) Inventor: SOHAIL MAHAMMAD, Bhadradri Kothagudem (IN)

(21) Appl. No.: 18/011,294

(22) PCT Filed: May 14, 2021
(86) PCT No.: PCT/IB2021/054129

§ 371 Date: Dec. 19, 2022

(30) Foreign Application Priority Data
May 19, 2020 (IN) 202041020979

(51) Int. Cl. G06Q 50/00

(52) U.S. Cl. CPC G06Q 50/01

(57) ABSTRACT

Exemplary embodiments of the present disclosure directed towards a computer-implemented system to create wisdom network, comprising wisdom generating module configured to enable at least one of first user and second user to post metadata on at least one of first computing device and second computing device via network, wherein the wisdom generating module configured to identify the intent of the metadata by using artificial intelligence technique and a blockchain technology and the wisdom generating module configured to enable the at least one of the first user and the second user to generate a response using the at least one of the first and the second computing device, the wisdom generating module configured to analyze the intent of the metadata and detect one or more likeminded profiles and send the one or more likeminded profiles as matches to at least one of the first computing device and the second computing device.

### TECHNICAL FIELD

The disclosed subject matter relates generally to wisdom network or social advisory network. More particularly, the present disclosure relates to a computer implemented system and method for managing well-being goals with the help of the wisdom of the crowd and facilitating to seek financial benefits to the users.

### BACKGROUND

Currently, we have come across many knowledge platforms, social networking sites and dating applications. If we fundamentally observe the purpose of those applications, it makes us understandable that knowledge applications are targeting to provide knowledge, and the social spaces are designed with the purpose of social networking. However, when the information is being uploaded every now and the concept of relationships becoming more virtual with advent of millennial and Gen Z, it doesn't leave the opportunity for the companies already existing in the social network to provide more solutions and benefits to the end-users because of their induced revenue model of primarily making money out of the targeted advertisements and selling insights to other businesses on the application. The major drawbacks of the organizations offering services in the space of knowledge and social networks are not able to offer wisdom network. The current methods of singularity aimed networks are trained to identify the words of the input and are supposed to display something related to that post, if that is regularly done, the interest of the end-user, intelligence of end-user decides the outcomes. Hence, there is a need to develop a system to create a wisdom network with the help of artificial intelligence and block chain technology to identify the intent of metadata available on the network and to convert that knowledge into wisdom for the end-users on the network.

In the light of aforementioned discussion, there exists a need for a system and method that would overcome or ameliorate the above-mentioned limitations.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards eliminating the problem of the wisdom to the first and second users by using machine learning techniques.

Another objective of the present disclosure is directed towards securing and decentralizing the wisdom network by applying the blockchain technology.

Another objective of the present disclosure is directed towards generating entire value of data and giving back to users which is usually taken away by centralized data maintain organizations in the field of social network, knowledge handling.

Another objective of the present disclosure is directed towards decentralizing the metadata in a network.

Another objective of the present disclosure is directed towards using blockchain technology in the space of social advisory network.

Another objective of the present disclosure is directed towards increasing the security and reducing the fake content by applying the blockchain technology and crowd intelligence.

Another objective of the present disclosure is directed towards allowing the first and second users to manage the physical, mental and financial wellbeing with the help of wisdom of the crowd.

Another objective of the present disclosure is directed towards providing the end-users to seek the financial benefits by expressing something that could help the people.

Another objective of the present disclosure is directed towards allowing the each individual user (first and second user) to create their personal goals and facilitating to achieve the personal goals with the help of artificial intelligence technique.

Another objective of the present disclosure is directed towards allowing every user (first and second user) in the network to post metadata (content) or to perform bit sized blogging to create value for other well-being in the network with his knowledge.

Another objective of the present disclosure is directed towards providing matching with likeminded people to be a part of the wisdom ecosystem and here the matches are decided upon the reach of a person's post to privates of others in network.

Another objective of the present disclosure is directed towards providing maximum matches to the individuals as incentive for helping more people in the network.

Another objective of the present disclosure is directed towards providing an opportunity to validate the posts in the network by placing stake lead to the growth of incentives for the user along with the reputation.

According to an exemplary aspect, a system comprising a wisdom generating module configured to enable at least one of a first user and a second user to post metadata on at least one of a first computing device and a second computing device via a network.

According to another exemplary aspect, the wisdom generating module configured to identify the intent of the metadata by using an artificial intelligence technique and a blockchain technology and the wisdom generating module configured to enable the at least one of the first user and the second user to generate a response using the at least one of the first and the second computing device.

According to another exemplary aspect, the wisdom generating module configured to analyze the intent of the metadata and detect one or more likeminded profiles and send the one or more likeminded profiles as matches to at least one of the first computing device and the second computing device.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting an example environment in which aspects of the present disclosure can be implemented. Specifically, FIG. 1 is a diagram depicting a schematic representation of a system for creating wisdom network, in accordance with one or more exemplary embodiments.

FIG. 2 is an example diagram depicting the wisdom generating module 112, in accordance with one or more embodiments.

FIG. 3A is a diagram depicting the home page screen in accordance with one or more embodiments.

FIG. 3B is a diagram depicting the add expression note screen in accordance with one or more embodiments.

FIG. 3C is a diagram depicting the expressions screen in accordance with one or more embodiments.

FIG. 3D is a diagram depicting the bunker screen in accordance with one or more embodiments.

FIG. 3E, FIG. 3F and FIG. 3G is a diagram depicting the bunker screen, bunker review list screen, and profile screen in accordance with one or more embodiments.

FIG. 4 is a flowchart depicting an exemplary method for detecting and sending the likeminded profiles as matches to the users for the metadata posted on the computing device, in accordance with one or more exemplary embodiments.

FIG. 5 is a flowchart depicting an exemplary method to stake the metadata, in accordance with one or more exemplary embodiments.

FIG. 6 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

Referring to FIG. 1 is a block diagram 100 depicting an example environment in which aspects of the present disclosure can be implemented. Specifically, FIG. 1 is a diagram depicting a schematic representation of a system for creating wisdom network, in accordance with one or more exemplary embodiments. The system 100 may be a computer-implemented system to create a wisdom network. The system 100 includes a first computing device 102, a second computing device 104, a database 106, a network 108, and a cloud server 110. The computing devices 102, 104 may include, but not limited to, a computer workstation, an interactive kiosk, and a personal mobile computing device such as a digital assistant, a mobile phone, a laptop, and storage devices, backend servers hosting database and other software and the like.

Although the computing devices 102, 104, are shown in FIG. 1, an embodiment of the system 100 may support any number of computing devices. The computing device 102/104 supported by the system 100 is realized as a computer-implemented or computer-based device having the hardware or firmware, software, and/or processing logic needed to carry out the computer-implemented methodologies described in more detail herein.

The first computing device 102 and the second computing device 104, may include a wisdom generating module 112, which may be accessed as mobile applications, web applications, software applications, that offers the functionality of accessing mobile applications, and viewing/processing of interactive pages, for example, are implemented in the computing devices 102 and 104 as will be apparent to one skilled in the relevant arts by reading the disclosure provided herein. The wisdom generating module 112 may be downloaded from the cloud server 110. For example, the wisdom generating module 112 may be any suitable applications downloaded from, GOOGLE PLAY® (for Google Android devices), Apple Inc.'s APP STORE® (for Apple devices, or any other suitable database. In some embodiments, the wisdom generating module 112 may be software, firmware, or hardware that is integrated into the computing devices 102, 104.

The network 108 may include but not limited to, a blockchain network, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

The first computing device 102 may be operated by a first user. The first user may include, but not limited to, user, individual, business organizations and so forth. The second computing device 104 may be operated by a second end user. The second user may include, but not limited to, participants, friends, bunkers, public, crowd, and so forth. The wisdom generating module 112 may be configured to enable the first user to post the metadata on the first computing device 102 via the network 108. The wisdom generating module 112 may be configured to identify the intent of the metadata available in the network and to convert the knowledge into wisdom for the first and second users on the network by using the artificial intelligence technique and blockchain technology. The wisdom generating module 112 may be configured to enable the second user to generate response through the second computing device 104 for the metadata posted by the first user. The metadata may include, but not limited to, images, videos, text, writings, information, statement, and so forth. The posting of metadata may be used to improve the services or the metadata that is being generated in the network and is clearly given back to the first and second users. The metadata may be the social posts that the user posts on the network.

The metadata may be completely decentralized and also gives the opportunity for the first and second users to personalize the content of metadata as per the first and second user requirements. The user requirements may include, but not limited to, physically, financially well-being and mentally which gives a full control, trust, and so forth. The blockchain technology may be applied in “wisdom network” to make the wisdom generating module 112 secured and decentralized. By inducing the blockchain technology the network may become an open network where the social posts of the each individual user is verified by the participants in the network to validate a content with semantic or visual keyword as lock.

The wisdom generating module 112 may be configured to improve the well-beings of each individual user (For example, First user) in the network using the wisdom of the second user. The well-being goals may include, but not limited to, health, finance, sports, fun, family, knowledge, and so forth. The wisdom generating module 112 may be accessed by the first user and the second user. The wisdom generating module 112 may be configured to improve with dynamic questions to enable the first and second user to interact with the system and also by using nature inspired theme to create an ambience of security and peace. The wisdom generating module 112 may be trained with the deep learning technique on large datasets to identify the intent of metadata (information, text, image and video). The wisdom generating module 112 may also be configured to receive the metadata posted by the first and second user in his private/bunker (private and public platforms such as “home” and “bunker”) and then the wisdom generating module 112 may processes the metadata to identify the intent of the metadata. The private area where the user shares his activities, doubts and feeling is completely private, anonymous and encrypted. This provides opportunity for the first and second user to improve his well-being goals (target goals) with the wisdom of the crowd but in a more secure and consumable way where the identity of person who is seeking the wisdom seems completely anonymous to network and other users in network. The wisdom generating module 112 may be configured to enable the first and/or second user to categorize the intent to different domains. The domains may include, but not limited to, education, health, finance, travel, entertainment, generic, relationship, and so forth. Once the intent is identified, the wisdom generating module 112 may understand the causes, effects, symptoms, precautions, and so forth, depending on the context of the intent. For example, a business situation of a user, the user would like to know the solutions and effects to his situations. The user may able to know the cause of any problem that he may face in the personal growth. Hence, the wisdom generating module 112 may be trained to identify the causes-effects, problems-solutions, symptoms-solutions, and so forth. The wisdom generating module 112 may map with the socials posts in the network by considering the well-being goals selected by the first and second user in his bunker/private and the intent of the situation. The social posts may be bit sized advices, suggestions received to the first and second users. Every social post that is being received to the second user may have been knowledge shared by the first user in the network and the social post may be verified by the public in the network. The wisdom generating module 112 may be configured to understand the situation and well-being goals of first and second user to map the right knowledge at right time and to provide the result in consumable and private area. The wisdom generating module 112 may be trained to understand the intent of the first and second user with metadata being decentralized. The control of metadata in the hands of the first and second user may enable the first and second user to know different insights, information and entertainment in a personalized way. The wisdom generating module 112 may also be configured to provide the opportunity to input the user data by the first and second user and seek results privately from the crowd that may help the first and second users to progress towards well-being goals. The user data may include, but not limited to, personal activities, memories, thoughts, feelings, doubts anonymously, and so forth. The database 106 may be configured to store the user data, metadata, well-being goals, user details and so forth. The wisdom generating module 112 may be configured to retrieve the metadata from the database 106 via the network 108.

For example, consider the wisdom generating module 112 as a market place, where the second user posts the valuable content in the market place to gain the reputation and profits. The valuable content may be selling/showcasing the knowledge. Whereas, the person, who seeks the information through bunker is basically consuming the value in it. Generally with the current environment of technological influence and the kind of mental happiness one is receiving through the virtual platform. The virtual platform may allow the people who would like to be recognized, respected, societal give back attitude to join the network and start gaining the recognition they are seeking. Apart from this, the person is building assets (reach data) and making value out of his activity. For example, if a student (first user) writes “starting to college” in the bunker, the first user may receive the social posts like, “There is no college today”. “Don't forget to bring your laptop while starting to college”. Basically the first user may write a situation in the bunker and the first user may receive the solutions, advises and infotainment related to the activities of the first user with the help of machine learning technique. When the first user posts a useful content, the useful content may reach to private networks increases as it has some valuable information. However, the first user may be able to post certain coins and allow the second users to bet on the post on a blockchain by creating a situation of social stock market. Then the first user may receive coins for every action and also by declaring his bunker data as well to improve the services to the user.

The second user may receive the social posts of the first user through a situational cross path may enjoy the benefit of the content and may add value to the post by locking with a key. This allows for social posts to be more useful as people may try to bet on more genuine content. After a time lock, the people in the bet may pay back with the valuation of the post and may pay according to the percentages. The posting of social posts of the first user may decide the stake distribution before initiating the post. The amount that is paid back to the second user in the network is the value of their metadata, i.e. the number of people or innovators or researchers or organizations or any another legitimate sources who may use the metadata to create anything valuable inside the network under regulatory conditions.

The wisdom generating module 112 may be configured to enable the first and second user to post the metadata that may add value to the others social posts. The wisdom generating module 112 may create a wisdom intelligence by avoiding false news/content. For example, the first user may decide the stake distribution of the social posts and allows second user to appreciate the post with the keyword such as “fun”, “motivating”, “bad” etc. This doesn't require any coins but the second users may get rewarded if they match with the keyword lock of the first user. This allows the second user to appreciate the posts and build wisdom in the network and at the same moment network is building valuable data but owned by the private owners. This means the data of a single person doesn't have much value, so being in the network provides an opportunity to make more value. The wisdom generating module 112 may use certain data points to improve physical, mental and financial well-being by suggesting content, plans, offers, assets, diet and fitness content.

In an example embodiment, let us assume a model, where the valuation of economy or generation of new coins happens through the assessment of the value or usability of data to various people/organizations in the network. The initial endowment has two options, initially when a first user gets into the network and fills the basic profile details and agrees for the terms and condition, according to market standards the value of the data may be deposited into the user's wallet. The wisdom networking module may allow the user to link his social networking, blogging history and browser history thereby enabling to evaluate and give coins as credit to the first user by accessing the amount and quality of metadata generated by the first user in the network. The wisdom generating module 112 may enable the first user or second user to generate a response and to write a post on the first and second computing devices 102, 104. The wisdom generating module 112 may enable the first and/or second user for stake distribution in the post and an option to appreciate the post. Usually the second user may invest in the post for a certain stake with a key. The key may include, a keyword, a comment, an emoji, and so forth. Once the stake is closed, other people in network may appreciate/comment on the post with the key (keyword and emoji). So at the end of time lock, the amount of data generated is calculated and assigns a value depending on the usability of the data to allow for personalized marketing and to create confess suggestion plans to help the first user in achieving the well-being goals. This allows the people to invest and support the post, which may avoid scam posts and encourage the users to support quality post, as the right key may create more value by earning more coins or may create reputational income for expressing our opinion on the post and allowing others in the network in making decision more comfortable.

In another example embodiment, the first user who posts in the network may generally receive coins, and allows the second user and others to invest in the network to decide the truthfulness of the post to gain reputational income or sometimes the first user may receive more money to the post due to support to the first user emotion, and may also result in downfall of a post or may create value that proves that wisdom of network looks at post the way you perceive it. For example, there are ten users (people) in the network, all the users decided to join cognitive bunker, so they initially fill their profile details (age, gender, interests etc) and due to the value of metadata in the market, we are giving the coins to the users and provides the user with an option to prove his activity ability through his history by integrating his various social networking applications. The value of data refers to the amount of money the businesses may be willing to pay to receive the service of insights. (Certain part of this metadata may be used to enhance the services). After analyzing the amount of potential data the user can generate, the user may be rewarded with certain amount of coins. The potential data may refers to the analyzing the average time and average posts made by people of different geographic locations, different age group and different financial situation. For example, assume ten coins have been released to all the ten users in the network. So the total number of coins in the network is 90 coins. Now user1 in the network posts a post related to food habits on the computing devices 102, 104 using the wisdom generating module 112. The wisdom generating module 112 may allow maximum stake on the user1 posts with two coins (For example) and allows for maximum of ten coins (For example) for stake distribution. Then, four users bought 20% stake for 2 “S” coins each accounting for total of five users and 10 “S” coins on a post and the post reaches to other five users in the network, this allows for data to be generated, The wisdom generating module 112 may be configured to analyze the topic, usage of data to enhance the users physical, mental and financial wellbeing according to the users choice of chosen well-being goals.

The network may provide an option such as appreciation token, when the entire stake of a post is full, users in the network may lock with an opinion on the post and when time stamp is close, if your opinion is contrary to the writers post (first user) and gains support from network, then the supporters data may fetch coins to the first user on the network who posted in contrary and gained similar support, this gets 70% of coins to first identifier of post and 30% gets distributed for other persons who supported or lately posted with similar appreciation token in contrary to writers key. If the appreciation tokens of users in the network are in alignment with writers and stake holders opinion, then user gets rewarded with incentive of one coin for reviewing the network and the appreciation token when posted in contrary, if does not gain minimum trust from network, the user may need to pay minimum stake of post through his Go coins. Once users have coins in the wallet, they may be useful to purchase any good, service, and property and for any other legitimate transaction. For example, if a user wants to buy a coffee, he just writes in his bunker and he receive all the best stores, combos and other offers from various users in the network and confess provides the suggestion to the user, like best coffee and sandwich which can offer necessary ingredients to his body and something that may keep in his budget range to fulfill the financial wellbeing goal the user has set and through a smart contract, the user may order and when the user receives, coins automatically get deducted from users wallet.

The wisdom generating module 112 may be created using deep learning technique and block chain technology with many business applications that maybe integrated. The services may be improved in creating personalized virtual magazines to first and second user using machine learning techniques. The first and second user may have scope to create mini bunkers to add personal goals, philosophies and to receive posts that may help the first and second user in achieving targeted goals with information, connections and advises. The wisdom generating module 112 may also works for business organizations to integrate the business goals, compliance policies, talent management, attendance management and managers insights for every user to access, manage, verify, learn on a decentralized block chain where entire data is encrypted. The wisdom generating module 112 may be configured to personalize the employee experience and to reduce costs for entire business process costs of unit.

In another example embodiment, the wisdom generating module 112 may have services that may be used as wealth management tool for every individual and businesses to monitor their everyday expenses and suggesting with the content that may help an individual to improve their wealth through verified investment opportunities and taking land insurances to maintain, monitor and improve the properties. The wisdom generating module 112 may also be configured to use in the health industry where every user is suggested with diet depending upon his health goals and financial standards without providing any loss of quality. Every individual may get his health monitor by taking simulation services to predict the health situation and to suggest alerts, expert advices and technological solutions. The entire health data is encrypted and decentralized and the user may disclose certain amounts of data for coins but may control the content with well-being goals.

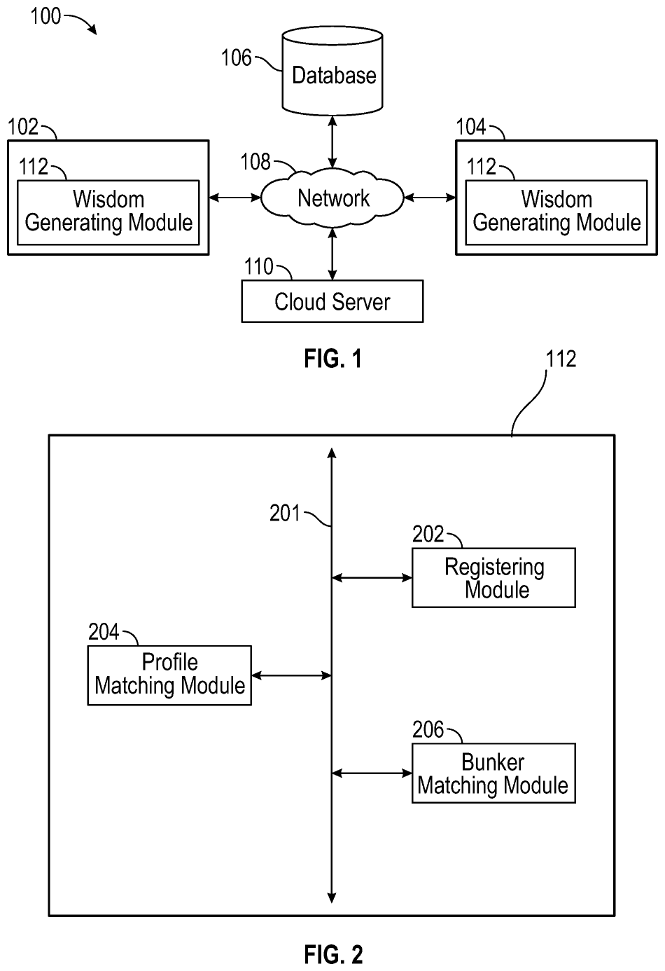

Referring to FIG. 2 is an example diagram 200 depicting the wisdom generating module 112, in accordance with one or more embodiments. The diagram 200a includes, a bus 201, a registering module 202, a profile matching module 204, and a bunker matching module 206. The term “module” is used broadly herein and refers generally to a program resident in the memory of the computing devices 102, and 104. The bus 201 may include a path that permits communication among the modules of the wisdom generating module 112, The registering module 202 may be configured to enable the first and/or second user to sign-up on the computing devices 102, and 104 by providing the user's details. The user's details may be interrogated by the wisdom generating module 112, which include a user's last name, a user's first name, a user's mobile number, a user's age, select gender, a user's occupation, a user's email, a user's password, a confirm password, and so forth. The registering module 202 may be configured to enable the end-user to login on the computing devices 102, 104 by providing the required identity credentials. The identity credentials may include, but not limited to, name, mobile number, age, gender, occupation, email identity, password, and so forth.

The profile matching module 204 may be configured to match the profile of the first and second users by using deep learning techniques, where the metadata may be given as an input by the first and second users may go through an automated processing. The domain of the metadata may be classified by using pre-trained data sets. The datasets may be created with the expressions that could fit into particular domains. The metadata may goes through the next level of machine learning identification model where the profile matching module 204 may be configured to analyze the intent in the text data. The intent may include, but not limited to, actions, emotions to determine the category of the text data. The profile matching module 204 may send the metadata to the cloud server 110 where the artificial intelligence technique may analyze the metadata available in the network and matches the posts with the content uploaded by the first user, the profile matching module 204 may pull out the profiles of the second user who share the post with similar intent may get matched.

The processing and cleaning, and building a neural network model may be performed with LSTM, B-LSTM and RNN. The deep learning model may be trained on small datasets and able to get 80% accuracy on unseen data. Once a particular domain is identified then the data is classified based on the “Intent”. For Intent classification, the customized data may be used to train the deep learning model using LSTM, B-LSTM and RNN techniques to identify the Intent of any particular statement in any domain. Once the intents are identified, the neural network model may be trained to identify the intent of the causes and effects of the primary intent identified from any expression. The deep learning model may be trained on specific domains. Primarily, the deep learning model may be trained on specific domains trying to comprehend physical, mental and financial well-being. However the data that comes out of the specific domains may progress as input to the generic algorithm. The generic algorithm is word2vec model, where every single word in any expression may be considered as vector and the relativity among the words have been considered as vectors are identified to display the outputs. The bunker matching module 206 may be configured to store the activities, doubts and feelings of the first and second user by interacting with a pre designed BOT questions. For example, “sup?! Whats going on?” “Feeling right now and why” and “Important note” and so forth.

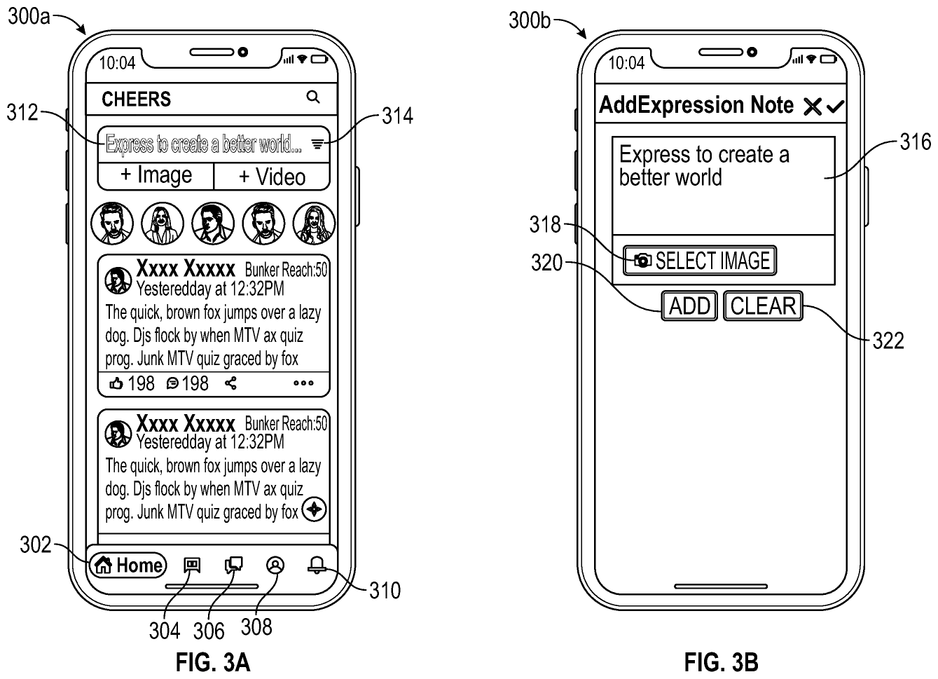

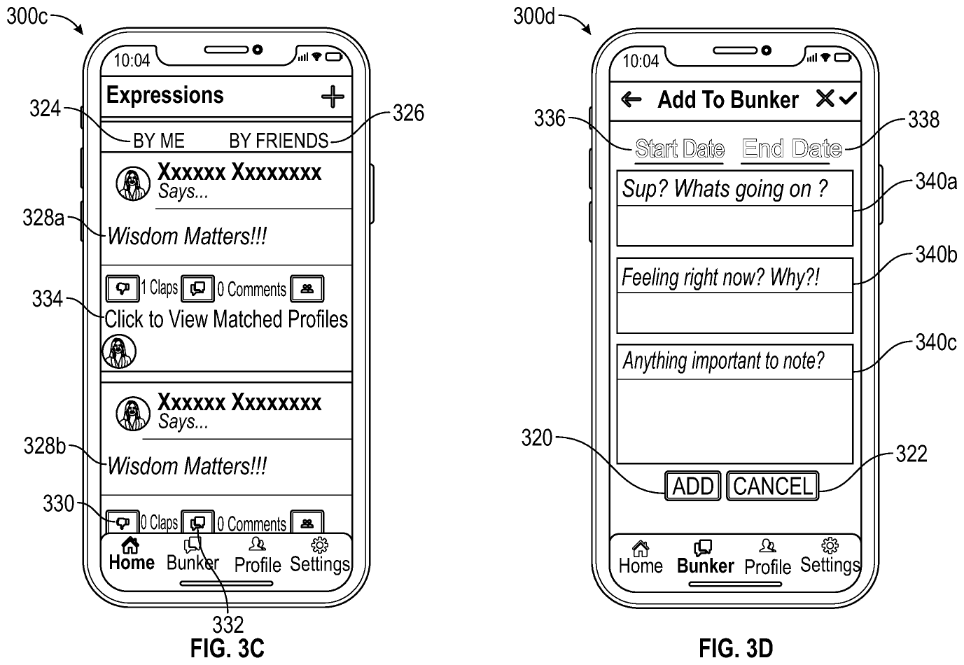

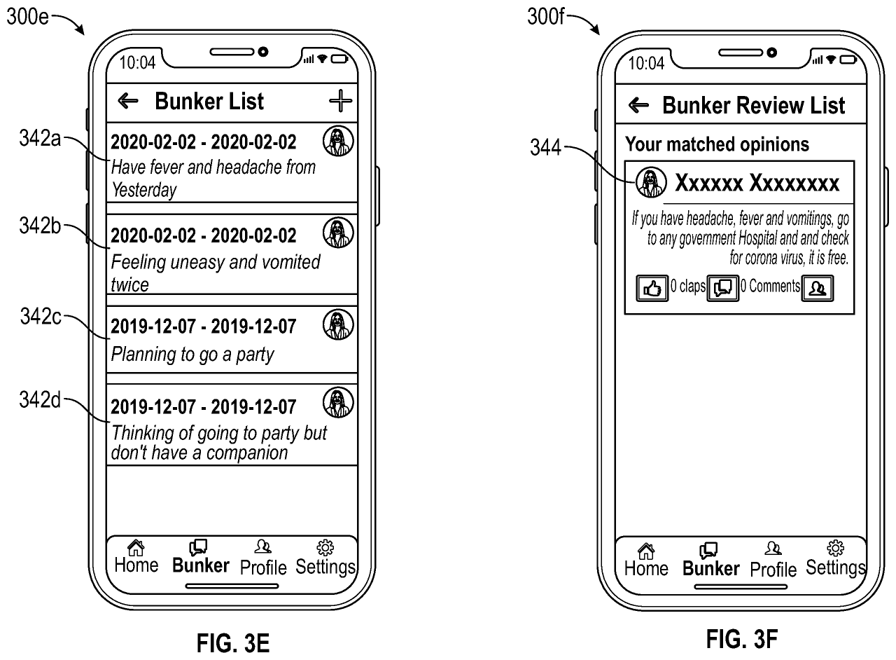

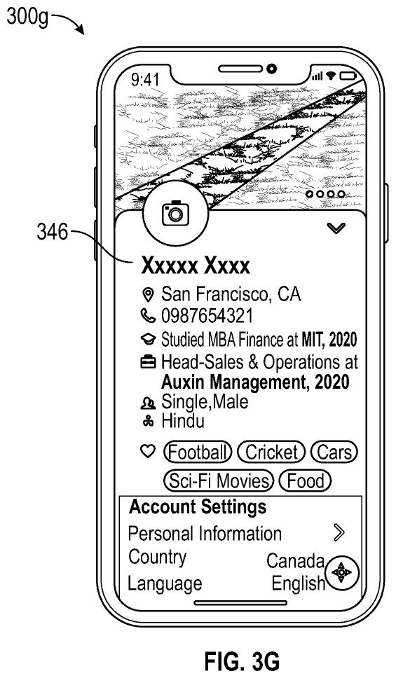

Referring to FIG. 3A is a diagram 300a depicting the home page screen in accordance with one or more embodiments. The home page screen 300a includes, a home page option 302, a bunker 304, chats option 306, a profile option 308, and notifications option 310, an express to create a better world option 312, and a filter option 314. The home option 302 may be configured to display the home screen on the computing devices 102, 104. The home screen 300a may be configured to provide an opportunity to the each individual user (For example, first user and second user) to post the metadata to the public. The bunker 304 may be a virtual private place for the users in the network to save the user data by interacting with a pre-designed BOT to let user answer his doubts with questions. For example, “sup?! Whats going on?” “Feeling right now and why” and “Important note”. The user data saved in the bunker 304 maybe encrypted and the block chain technology may result in the complete data decentralization which guarantees security. Once the first and second user saves his activity in the bunker 304, the wisdom generating module may allow the first and second user to move in a new page where post matches are delivered. However, the complete control of user to fix his well-being goals such as health, finance, sports, fun, family, knowledge and so forth, which may intricately divided in the later developments.

The chats option 306 may be configured to establish the communication between the first and second user. The profile option 308 may be configured to enable the first user and the second user to edit the user profile details. The user profile details may include, but not limited to, name, place, address, likes, number, community, marital status, and so forth. The notifications option 310 may be configured to display the notification updates received from the second users. The notification updates may include, but not limited to, likes, dislikes, comments, messages, reply, posts, and so forth.

The express to create a better world option 312 may be configured to enable the end-user to post the media data on the computing devices 102 and 104. The filter option may be configured to enable the first user to filter the anonymous, only bunkers, only friends, friends & bunker and so forth. The filter option 314 may be configured to provide the first user with an opportunity to control the reach of his content to the second user depending upon the need of the content. The user who posts the metadata (media content) may have an opportunity to receive matched profiles in the network who have posted similar content. This provides the user with a controllable opportunity to connect with likeminded individuals on the network. The Home page screen 300a may include an opportunity to post to second user and to receive likeminded matches as one opportunity. The bunker 304 may be configured to record the user data and to seek the wisdom of crowd privately by knowing their insights, suggestions, experiences, feelings privately. This kind of matching is achieved by using machine learning techniques.

Referring to FIG. 3B is a diagram 300b depicting the add expression note screen in accordance with one or more embodiments. The screen 300b includes, an input bar 316, a select image option 318, an add option 320, and a clear option 322. The input bar 316 may be configured to enable the first and second user to input the metadata. The select image option 318 may be configured to enable the first and second user to select image from the local storage of the computing devices 102 and 104. The add option 320 may be configured to enable the first and second user to post the metadata (expression) in the public network. The clear option 322 may be configured to enable the first and second user to cancel the posting of metadata in the network.

Referring to FIG. 3C is a diagram 300c depicting the expressions screen in accordance with one or more embodiments. The screen 300c includes, a By me option 324, By friends option 326, expressions 328a-328b, a like/dislike icon 330, a comment option 332, view matched profiles option 334, the home page option 302, the bunker 304, and the profile option 308. The By me option 324 may be configured to enable the first and second user to view the metadata posted by the first user. The By friends option 326 may be configured to enable the first and second user to view the metadata posted by the friends of the first user on the computing devices 102/104. The expressions 328a-328b may be posted by the first user. The like/dislike icon 330 may be configured to enable the first user and the second user to like/dislike the posted content on the computing device 102/104. The comment option 332 may be configured to enable the first user and the second user to share the comment on the postings. The view matched profiles option 334 may be configured to enable the first user and the second user to view the matched profiles of the similar posts (Likeminded people).

The bunker 304 may be a private place and anything written in the bunker is completely anonymous to user and our business. For example, when a user interacts with the system, where the user interface gives a sense that it is more private place and allows user to write more related to his everyday activities, thoughts, doubts and feeling. The activities gets saved in the screen known as “memories”. Memories is internal page of bunker. Memories is a page where all the activities in bunker are saved. Once the user selects the saved activity in bunker, the user may navigate to “cheer room”. Cheer Room is a page where user may receive advises, feedbacks, insights, entertainment to enhance the situation and to help the user achieve his well-being goals. The metadata (content) received to bunker is the metadata posted by the other users in network. The user may receive the verified metadata as everyone stakes and verifies the metadata. [Matches in the bunkers are achieved with a deep learning technique trained to identify the intent of the metadata, causes and effects of intent and the algorithm matches with the posts in the network that has similar intents.] The user who receives the matches in bunker may also post stake on the posts received by the user. The user may also able to declare the metadata to earn more coins.

Referring to FIG. 3D is a diagram 300d depicting the bunker screen in accordance with one or more embodiments. The screen 300d includes, a start date 336, an end date 338, questions 340a, 340b and 340c, the add option 320, and the clear option 322. The start date 336 and the end date 338 may be configured to store the metadata in the bunker. The questions 340a, 340b, and 340c may be configured to enable the first and second user to input the answer. The add option 320 may also be configured to store the posts in the bunker. The clear option 322 may also be configured to enable the first and second user to cancel the storing of post in the bunker.

Referring to FIG. 3E, FIG. 3F and FIG. 3G is a diagram 300e, 300f, and 300g depicting the bunker screen, bunker review list screen, and profile screen in accordance with one or more embodiments. The screen 300e includes, bunker list 342a, 342b, 342c and 342d. The bunker list 342a, 342b, 342c and 342d may be configured to display the metadata stored in the bunker by the first and second user. The screen 300f includes, bunker review list 344. The bunker review list 344 may be configured to display the reply received from the matched profile to the post. The screen 300g includes, a user profile details 346. The user profile details 346 may be configured to display the registered user profile details of the user (first user or second user).

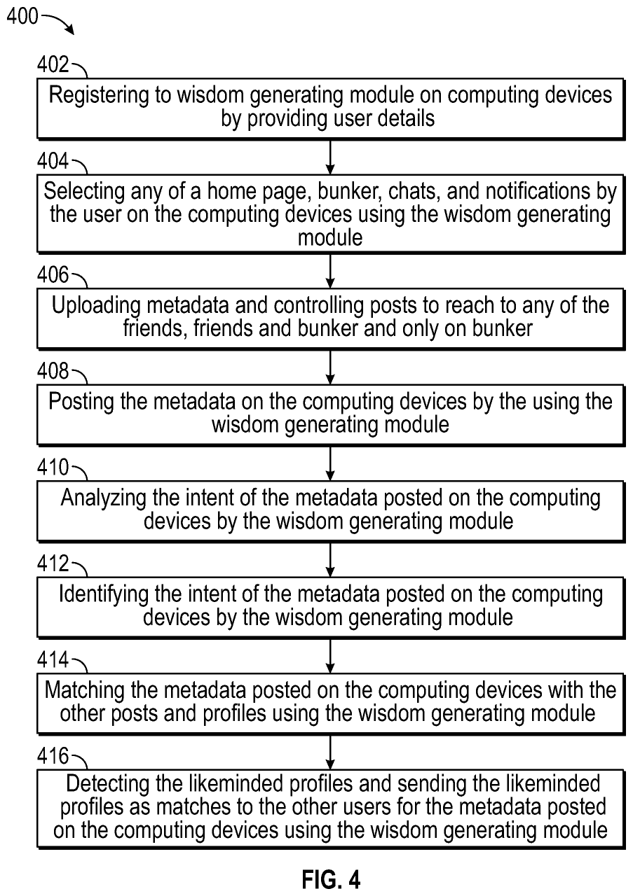

Referring to FIG. 4 is a flowchart 400 depicting an exemplary method for detecting and sending the likeminded profiles as matches to the users for the metadata posted on the computing device, in accordance with one or more exemplary embodiments. As an option, the method 400 is carried out in the context of the details of FIG. 1, FIG. 2, and FIG. 3. However, the method 400 is carried out in any desired environment. Further, the aforementioned definitions are equally applied to the description below.

The exemplary method 400 commences at step 402, registering to the wisdom generating module on the computing devices by providing the user details. Thereafter at step 404, selecting any of the home page, bunker, chats, and notifications by the user on the computing devices using the wisdom generating module. Thereafter at step 406, uploading the metadata by controlling the posts to reach to any of the friends, friends and bunker and only on bunker. Thereafter at step 408, posting the metadata on the computing devices by the using the wisdom generating module. Thereafter at step 410, analyzing the intent of the metadata posted on the computing devices by the wisdom generating module. Thereafter at step 412, identifying the intent of the metadata posted on the computing device by wisdom generating module. Thereafter at step 414, matching the metadata posted on the computing devices with the other posts and profiles using the wisdom generating module. Thereafter at step 416, detecting the likeminded profiles and sending the likeminded profiles as matches to the other users for the metadata posted on the computing devices using the wisdom generating module.

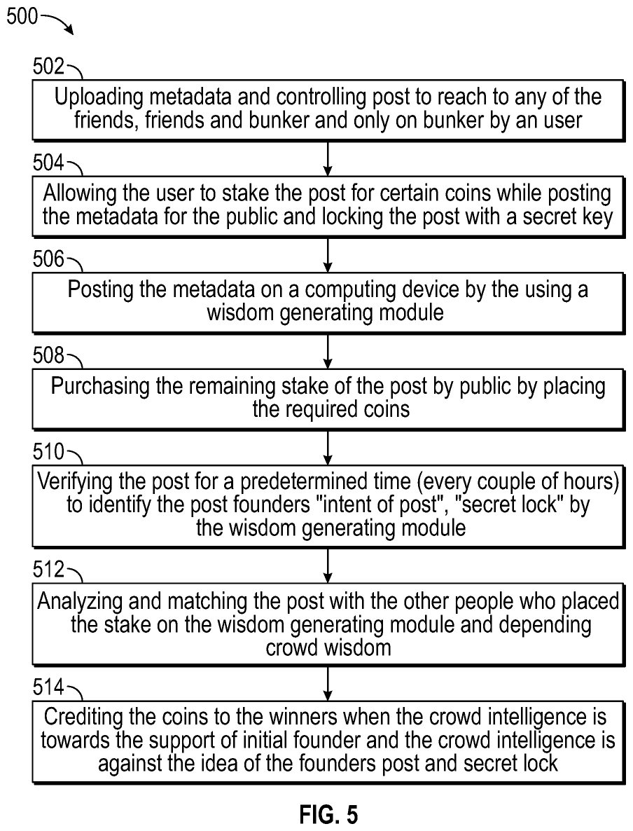

Referring to FIG. 5 is a flowchart 500 depicting an exemplary method to stake the metadata, in accordance with one or more exemplary embodiments. As an option, the method 500 is carried out in the context of the details of FIG. 1, FIG. 2, FIG. 3, and FIG. 4. However, the method 500 is carried out in any desired environment. Further, the aforementioned definitions are equally applied to the description below.

The exemplary method 500 commences at step 502, uploading the metadata and controlling the posts to reach to any of the friends, friends and bunker and only on bunker by the user. Thereafter at step 504, allowing the user to stake the post for certain coins while posting the metadata for the public and locking the post with a secret key. Thereafter at step 506, posting the metadata on the computing device by the using the wisdom generating module. Thereafter at step 508, purchasing the remaining stake in the post by the public by placing the required coins. Thereafter at step 510, verifying the post for a predetermined time (every couple of hours) to identify the post founders “intent of post”, “secret lock” by the wisdom generating module. Thereafter at step 512, analyzing and matching the post with the other people who placed the stake on the wisdom generating module and depending crowd wisdom. Thereafter at step 514, crediting the coins to the winners when the crowd intelligence is towards the support of initial founder and the crowd intelligence is against the idea of the founders post and secret lock.

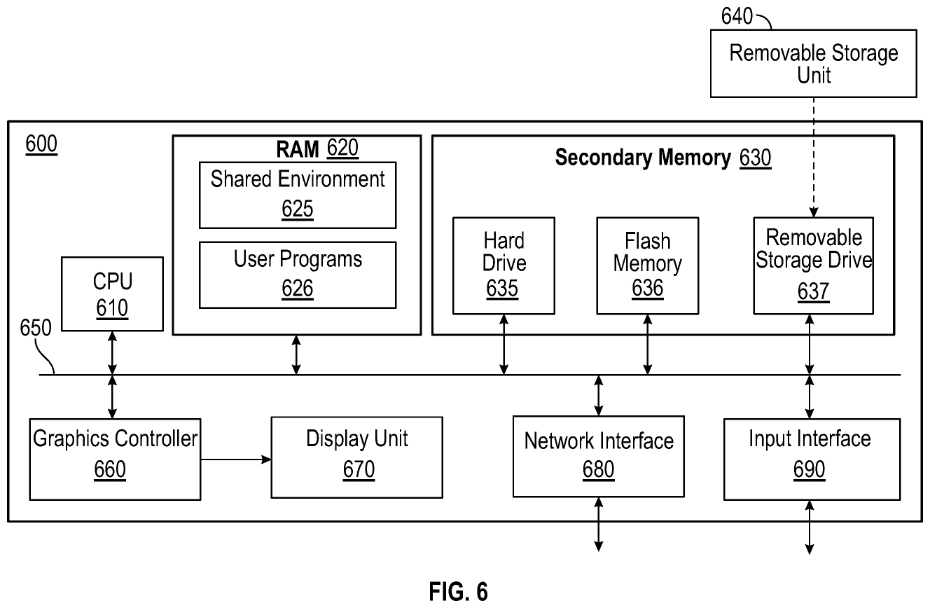

Referring to FIG. 6 is a block diagram 600 illustrating the details of a digital processing system 600 in which various aspects of the present disclosure are operative by execution of appropriate software instructions. The Digital processing system 600 may correspond to the computing device 102, 104 (or any other system in which the various features disclosed above can be implemented).

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions, such as those used in threads and stacks, constituting shared environment 625 and/or user programs 626. Shared environment 625 includes operating systems, device drivers, virtual machines, etc., which provide a (common) run time environment for execution of user programs 626.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems (such as those shown in FIG. 1) connected to the network 108.

Secondary memory 630 may contain hard drive 635, flash memory 636, and removable storage drive 637. Secondary memory 630 may store the data software instructions (e.g., for performing the actions noted above with respect to the Figures), which enable digital processing system 600 to provide several features in accordance with the present disclosure.

Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EEPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

1. A computer implemented system to create wisdom network, comprising:
a wisdom generating module configured to enable at least one of a first user and a second user to post metadata on at least one of a first computing device and a second computing device via a network, wherein the wisdom generating module configured to identify the intent of the metadata by using an artificial intelligence technique and a blockchain technology and the wisdom generating module configured to enable the at least one of the first user and the second user to generate a response using the at least one of the first and the second computing device, the wisdom generating module configured to analyze the intent of the metadata and detect one or more likeminded profiles and send the one or more likeminded profiles as matches to at least one of the first computing device and the second computing device.

2. The system as claimed in claim 1, wherein the wisdom generating module configured to enable the first and/or second user to categorize the intent to different domains.

3. The system as claimed in claim 1, wherein the wisdom generating module configured to improve one or more well-beings of the first user in the network using the wisdom of the second user.

4. The system as claimed in claim 1, wherein the wisdom generating module configured to enable the first and/or second user for stake distribution in the post and an option to appreciate the post.

5. The system as claimed in claim 1, wherein the wisdom generating module comprising a profile matching module is configured to match one or more profiles of one or more users by using deep learning techniques.

6. The system as claimed in claim 1, wherein the wisdom generating module comprising a bunker matching module is configured to store one or more activities, doubts and feelings of the first and second user by interacting with a pre designed BOT questions.

7. A computer implemented method to create wisdom network, comprising:
registering to a wisdom generating module on computing devices by providing user details;
posting metadata on the computing device by the using the wisdom generating module;
analyzing an intent of the metadata posted on the computing devices by the wisdom generating module;
identifying the intent of the metadata posted on the computing devices by wisdom generating module;
matching the metadata posted on the computing devices with the other posts and profiles using the wisdom generating module; and
Detecting one or more likeminded profiles and sending the one or more likeminded profiles as matches to the users for the metadata posted on the computing devices using the wisdom generating module.
